(19) United States
(12) Patent Application Publication
(10) Pub. No.: US 2026/0095258 A1
(43) Pub. Date: Apr. 2, 2026

(54) INAUDIBLE ORTHOGONAL SIGNAL COMMUNICATION

(71) Applicant: Amazon Technologies, Inc., Seattle, WA (US)

(72) Inventors: Syed Abdullah Nauroze, Ottawa (CA); Eugene Ren, Palo Alto, CA (US); Guangji Shi, San Jose, CA (US); Abhay Abhay, Jaipur (IN); Durgaprasad Kashinath Shamain, Los Gatos, CA (US); Akshay Mohan, San Jose, CA (US); Gurpal Singh Gill, San Jose, CA (US)

(21) Appl. No.: 18/902,109

(22) Filed: Sep. 30, 2024

(51) Int. Cl. H04B 11/00; H04B 1/69; H04L 5/00

(52) U.S. Cl. CPC H04B 11/00; H04B 1/69; H04L 5/0007

(57) ABSTRACT

Methods are generally described for inaudible orthogonal signal communication. An example method includes determining, based on an input message, a series of symbols, where each symbol from the series of symbols represents a numerical value, wherein each symbol from the series of symbols corresponds to a band-limited white noise tone orthogonal to each other band-limited white noise tone corresponding to each other symbol. The example method also includes generating a sub-token comprising each symbol from the series of symbols, where each symbol overlaps in time with at least one other symbol. The example method also includes modulating a carrier wave with the sub-token to produce a signal audio waveform, where the modulation uses a spread spectrum technique, and providing the signal audio waveform to a television device, where the television emits the signal audio waveform as a low-amplitude audio signal.

### BACKGROUND

Sound waves may be used to transmit information by various modulation techniques. For example, in the past, acoustic modems converted digital data into audible sounds to transmit over phone lines, which were demodulated back into digital data at the receiving end.

### BRIEF DESCRIPTION OF DRAWINGS

FIG. 1 is a diagram illustrating an example system for communicating with an inaudible orthogonal signal (IOS) protocol.

FIG. 2 is an illustration of signal amplitude versus time for an IOS token comprising three sub-tokens, each sub-token comprising six symbols, as used in accordance with various examples described herein.

FIG. 3 is an illustration of bandwidth spreading of IOS tones in comparison with frequency shift-keying (FSK) tones, as used in accordance with various examples described herein.

FIG. 4 is a block diagram illustrating an example of IOS communication between two devices, in accordance with various examples described herein.

FIG. 5 is an illustration of an example technique for overlapping orthogonal sub-tokens, as used in accordance with various examples described herein.

FIG. 6 illustrates an example apparatus effective to perform inaudible orthogonal signal communication, used in accordance with various aspects of the present disclosure

FIG. 7 is a block diagram illustrating an example process for inaudible orthogonal signal transmission, in accordance with various aspects of the present disclosure.

FIG. 8 is a block diagram illustrating an example process for emitting a signal via inaudible orthogonal signal communication, in accordance with various aspects of the present disclosure.

FIG. 9 is a block diagram illustrating an example process for receiving a signal via inaudible orthogonal signal communication, in accordance with various aspects of the present disclosure.

### DETAILED DESCRIPTION

In the following description, reference is made to the accompanying drawings that illustrate several examples of the present invention. It is understood that other examples may be utilized and various operational changes may be made without departing from the spirit and scope of the present disclosure. The following detailed description is not to be taken in a limiting sense, and the scope of the embodiments of the present invention is defined only by the claims of the issued patent.

Described herein are systems, techniques, and interfaces that may be used for transmitting and/or receiving signals using inaudible orthogonal signal (IOS) communications. A device may transmit an IOS signal using a speaker by selecting signal characteristics such that the IOS signal is not audible to humans in the emitted frequency spectra. IOS communications may be transmitted with a desired latency requirement for the encoding, sending, receiving, and decoding of the signal (e.g., typically within three seconds). IOS communications may also be detectable and transmittable for a wide variety of devices. For example, for an IOS communication via television, at least 80% of currently manufactured televisions meet the specifications required to transmit a detectable IOS signal.

The IOS protocol may enable devices to emit audio signals at frequency ranges typically audible to humans (e.g., 11-18.5 kHz) but at amplitudes that are inaudible to human hearing. The IOS protocol accomplishes this inaudibility by the use of a novel spread spectrum-based technique that may cause a device to transmit (and encode) and/or receive (and decode) inaudible tokens at human-audible frequency ranges without disrupting the experience of a user in the room where the IOS communication occurs.

Various examples using IOS communication disclosed within provide technical solutions that overcome challenges faced by previous approaches to signal transmission. For example, the human auditory system is fifteen times more sensitive in the 13-16 kHz frequency ranged compared to inaudible frequencies, such as those higher than 18 kHz. However, many devices transmitting linear and live channels may discard high frequency tones to save transmission bandwidth, making it impossible to use high frequency reliably in such cases. Even at audible frequencies, another challenge faced is that children typically have better hearing and hence can hear even feeble audible frequencies.

Further challenges regarding audibility include the use of randomness in signal tokens. Systems may use tokens comprising bandlimited white noise with high amplitude variations that can trigger audibility, so random fluctuations in white noise generation must be accounted for. Finally, user equipment such as speakers may have large variability in gain at various frequencies. For example, a significant fraction of speakers on consumer televisions have ten times greater gain at lower frequencies (approximately 13 kHz) compared to the 80% majority of devices, making them more susceptible for audibility. This variability in speaker gain also poses a problem for designing a protocol that maintains detectability for the majority of consumer devices. Non-linearities in most consumer device television speakers may include non-linearities that amplify abrupt changes in audio when a token is transmitted, which may result in varying received signal response throughout the token transmission duration. Additionally, the room dynamics and physical placement of devices may affect multipath response of the transmitted signals, requiring a protocol robust against multipath effects.

Regarding latency design requirements, a tradeoff may be found by optimizing for audibility and detection by using longer tokens at the cost of greater latency. High latency may be acceptable for some applications; however, high latency may result in losing customer attention and reducing the effectiveness of advertising based on IOS communications.

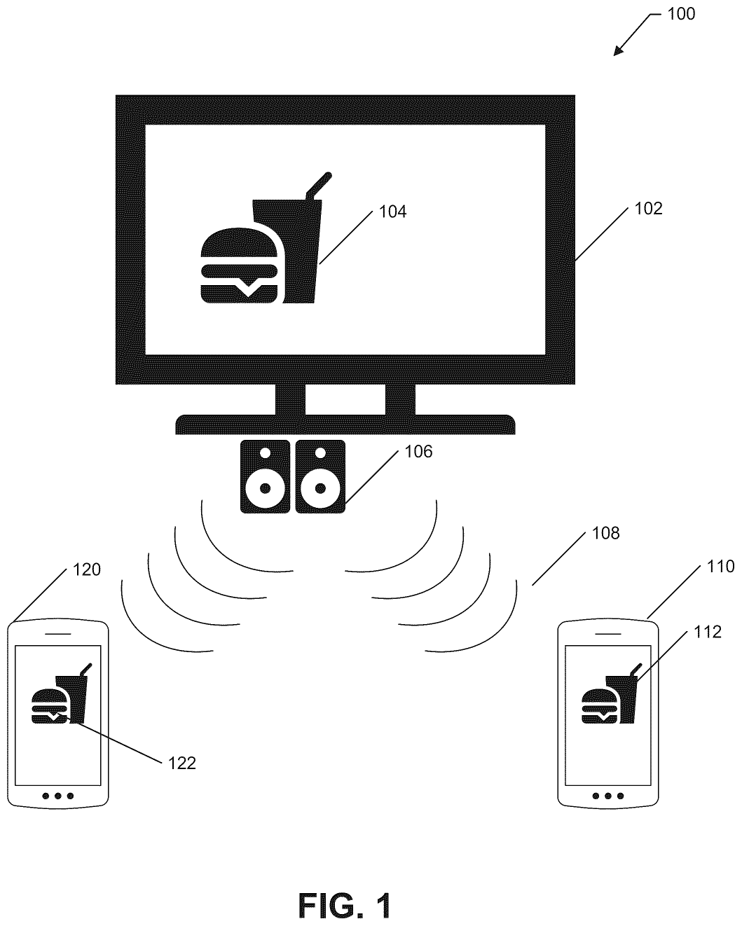

FIG. 1 is a diagram illustrating an example system 100 for communicating with an inaudible orthogonal signal (IOS) protocol. In example system 100, a television 102 may communicate with mobile device 110 using IOS communication. For example, the television 102 may display a standard television program, film, advertisement, and/or the like. Coinciding with a particular timestamp of the media displayed on the television 102, a product 104 may be displayed. The product 104 may be associated with a symbol comprising a string of bits (which may be represented as a string of hexadecimal values). The associated symbol may be transmitted using speakers 106 via IOS communication as an IOS transmission 108, which may be received by a user device such as mobile device 110. The mobile device 110 may detect the IOS transmission 108 via on-board microphone or other devices and decode the IOS transmission 108 to determine the symbol. The mobile device may then look up the product 104 information to display product 112 information matching product 104. It will be understood that example system 100 is merely one example implementing IOS communication, and IOS communication disclosed herein may be performed using a variety of example devices and configurations, as desired.

In some examples, another mobile device 120 may be present that may detect the IOS transmission 108 via an on-board microphone or other devices and decode the IOS transmission 108 to determine the symbol. The mobile device 120 may then likewise look up the product 104 information to display product 122 (which may be the same as product 112) matching product 104. It will be understood that mobile device 110 and/or mobile device 120 may interpret IOS transmission 108 when the appropriate software and/or data are loaded onto mobile device 110 and/or mobile device 120. The appropriate software and/or data may include spreading codes, tables for interpreting symbols, tables for matching tokens to various products, cryptographic keys, and/or the like. Accordingly, an unauthorized mobile device (not pictured) that does not include the appropriate software and/or data (e.g., an unauthorized device presenting a security risk) may, in some examples, be unable to interpret IOS transmission 108 due to a lack of software and/or data loaded on the unauthorized mobile device. It will be understood that IOS transmission 108 may be configured and constructed in such a way as to use encoding with varying levels of availability (e.g., publicly available or secured) to construct signals with the desired level of security and protection against unauthorized devices. For example, an IOS transmission 108 in a restaurant or a bar may be accessible using pre-loaded software available on most mobile devices. In another example, an IOS transmission 108 in a private home may use a special secure key available only to residents or guests of the private home.

In another illustrative example, a room may include multiple televisions (e.g., multiples of television 102). Accordingly, each television may have its own instance of speakers 106. Each television may be synchronized to transmit the same television program and the same IOS transmission 108, or each television may transmit different programs and thus broadcast different IOS transmissions (e.g., different instances of IOS transmission 108). For example, in a restaurant or bar, several televisions may each transmit different programs, each with different advertising and different IOS transmissions. Accordingly, each IOS transmission 108 may be constructed to use non-overlapping, orthogonal signals such that a mobile device 110 may receive signals from any or all of the televisions in range of the mobile device 110. In some examples, a mobile device 110 may be configured to ignore signals from certain televisions, for example, if a user wishes to focus on the program of a single television 102 and ignore others. In these examples, the IOS signal 108 and/or mobile device 110 may include additional measures to compensate for noise leakage, interference, and other effects of operating in a space where multiple IOS transmissions are sent and received.

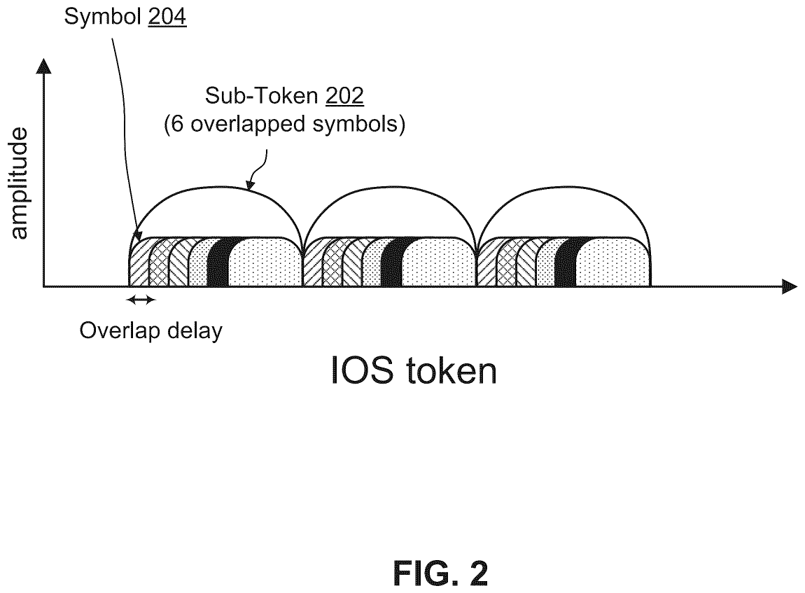

FIG. 2 is an illustration of signal amplitude versus time for an IOS token comprising three sub-tokens (such as sub-token 202), with each sub-token comprising six symbols such as symbol 204), as used in accordance with various examples described herein. The horizontal axis indicates time, and the vertical axis indicates amplitude. As seen in FIG. 2, the IOS token may be divided into several sub-tokens (including sub-token 202) which are non-overlapping in time. Each sub-token may include several symbols (including symbol 204) which are timed with an overlap delay so that each symbol overlaps in time with a symbol before and/or after itself. The number of sub-tokens, symbols, amount of delay, and other parameters of the IOS token may be configured to balance audibility, detectability, and latency for a desired application.

Each symbol 204, as depicted in FIG. 2, may represent a numerical value (e.g., a hexadecimal value). The symbols may correspond to a band-limited white noise symbols in the audible frequency range (e.g., 11-18.5 kHz). To ensure inaudibility of the symbols, the symbols may be attenuated significantly with respect to typical audio volumes produced by a device. For example, a television emitting audio below 75 dBSPL with IOS symbols attenuated 56 dB may achieve 100% inaudibility of the IOS signal.

As shown, symbol 204 may be overlapped in time with other symbols to reduce latency. Since symbols are unique and orthogonal, symbols may overlap in time without interfering with the detection of each overlapped symbol. However, there are practical limitations to the number of overlapped symbols that may be transmitted together due to audibility and detection requirements. For example, a large number of simultaneously overlapped symbols may be more audible than two or three overlapped symbols. In one example configuration, a token comprises three sub-tokens, where each sub-token 202 includes six overlapped symbols, as shown in FIG. 2.

Due to the orthogonality of the symbols (including symbol 204) depicted in FIG. 2, detection of overlapping symbols may be achieved by performing a calculation of the cross-correlation between a received signal and one or more known symbols. A peak in the cross-correlation for a particular known symbol may indicate a positive match and the presence of the particular known symbol in the sub-token at a given time.

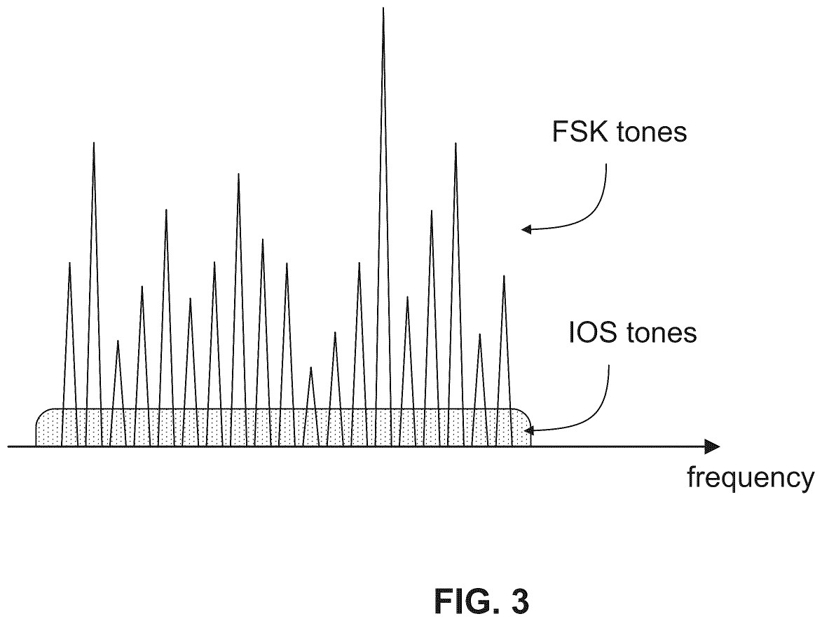

FIG. 3 is an illustration of bandwidth spreading of IOS tones in comparison with frequency shift-keying (FSK) tones, as used in accordance with various examples described herein. In FIG. 3, the horizontal axis depicts frequency, while the vertical axis depicts amplitude of an example signal. Typical high-frequency communication protocols, shown by the peaks labeled “FSK Tone” in FIG. 3, include high-amplitude FSK tones which may extend into the human-audible range. In contrast, the IOS protocol described herein may spread the signal energy through a wider bandwidth to enable the use of lower amplitudes. Lower signal amplitudes generally lead to lower audibility of IOS tones. Another benefit of frequency spreading is improved fidelity; IOS tones may not require a single tone to be detected for detectability. These properties may lead to greater resiliency against noise for IOS communications, and lower impact on any original audio signals that are paired with the IOS communication (e.g., audio from a television program, movie, music, or the like, that is transmitted simultaneously with the IOS signal). While certain examples of IOS communication are described in connection with a particular frequency band, signals may be transmitted at any frequency, which allows IOS to be adapted to work with various types of existing speaker hardware and configurations.

While frequency spreading with IOS brings the advantages described above, certain technical challenges must be overcome to implement the IOS protocol. For example, the signals IOS transmits should be chosen to be orthogonal, so that overlapping symbols may be transmitted (as described above in connection with FIG. 2). The extremely low amplitudes and spread frequencies also may result in higher latencies than traditional methods. Furthermore, the human auditory system has a non-linear response. Similarly, speakers found in typical consumer devices have nonlinearity in their output responses. As such, the amplitude of IOS transmissions may be chosen at each frequency band with this non-linearity in mind, in order to achieve and/or improve inaudibility. Finally, bandwidth limitations may be a factor, where less information may be encoded in lower frequency bands

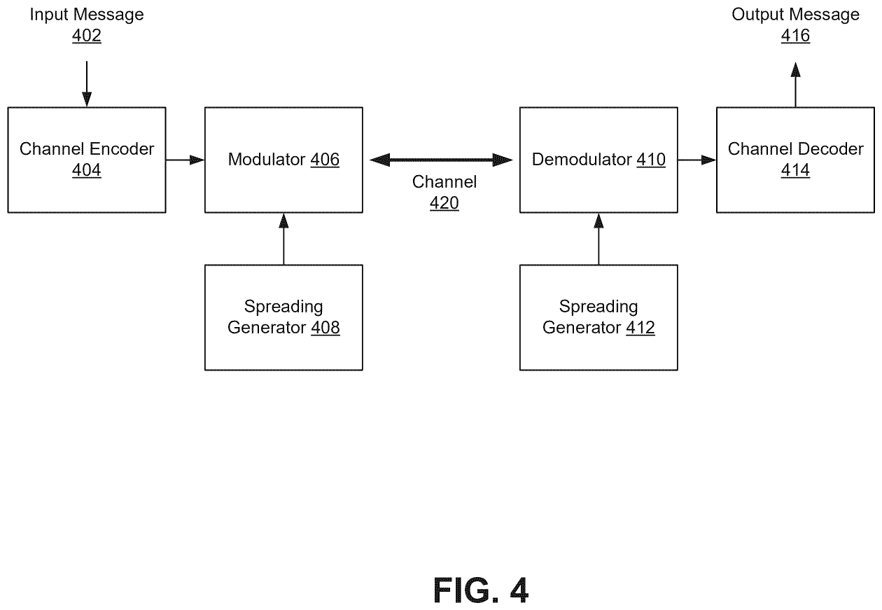

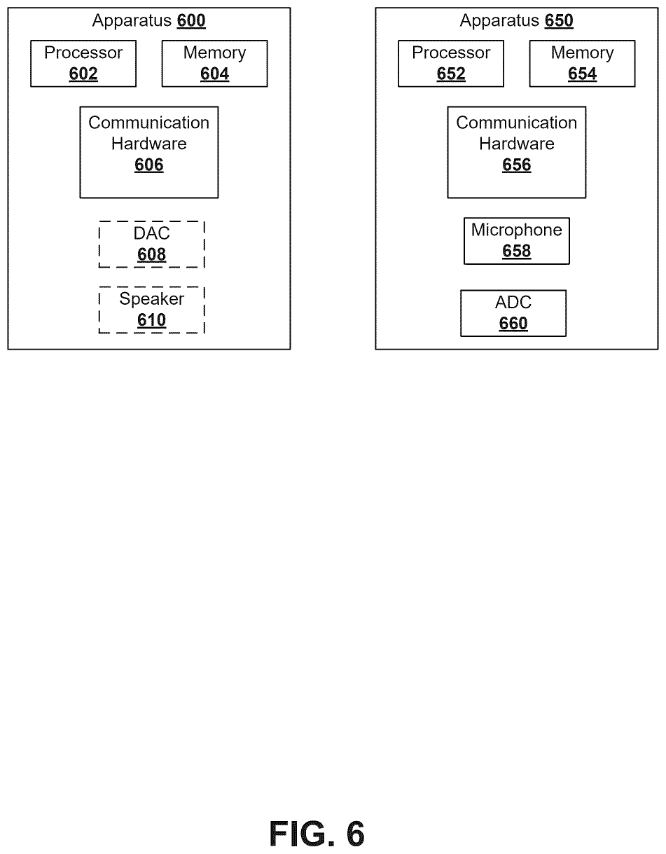

FIG. 4 is a block diagram illustrating an example of IOS communication between two devices, in accordance with various examples described herein. The devices may be embodied, for example, by apparatus 600 and apparatus 650, depicted in FIG. 6 and described below. For IOS communication, the channel 420 shown in FIG. 4 may represent audio waves propagating in air, mediated by a speaker and microphone on the transmitting and receiving devices, respectively. The input message 402 may be any general digital message, or an analog signal encoded into a digital bit pattern. The channel encoder 404 may receive the input message and perform digital encoding to produce an encoded message. The digital encoding may include measures such as error correction, inclusion of standard message start and/or message end signals, and/or any other measures to encode the input signal to enhance the reliability and security of the transmission. The modulator 406 may receive the encoded digital signal and then modulate a carrier signal to encode the information of the encoded digital signal. The modulator 406 may also operate with the spreading generator 408 to produce a spread spectrum signal. For example, the modulation may be performed using, for example, direct sequence spread spectrum (DSSS), frequency hopping spread spectrum (FHSS), or other techniques. The spread spectrum may use a spreading code, which may be, for example, band-limited white noise, pseudorandom noise, Gold sequences, or the like.

The demodulator 410 in conjunction with the spreading generator 412 may perform demodulation and de-spreading to produce an encoded digital signal. Finally, the channel decoder 414 may then decode the encoded digital signal to retrieve the output message 416. The processes depicted in connection with FIG. 4 represent an example implementation of the IOS communication protocol and may not each be used in every implementation of IOS. For example, demodulator 410 and spreading generator 412 may be separate components, or may be performed by the same component in a single step in some examples.

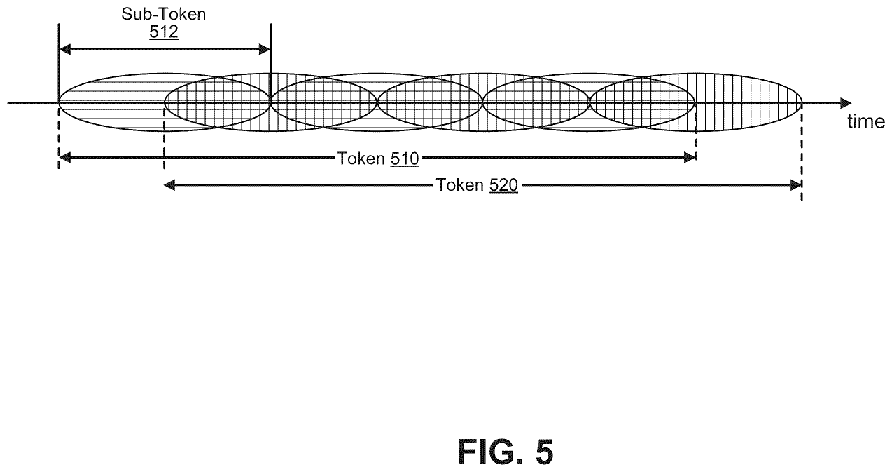

In some examples, various optional techniques may be used to extend the IOS communication protocol to improve various aspects. FIG. 5 is an illustration of an example technique for overlapping orthogonal sub-tokens, as used in accordance with various examples described herein. In examples in which multiple tokens are transmitted and it is critical to reduce latency, for example, tokens may be overlapped to produce overlapping tokens. Under certain conditions (e.g., available speaker hardware from the end-user device, room environment, distance, and/or the like) orthogonal tokens may be overlapped as shown in FIG. 5 without affecting detectability. Overlapping token 510 and token 520, as shown, may cause the overlap of individual sub-tokens from each token (for example, sub-token 512 from token 510 may overlap with the first sub-token from token 520). In the example pattern depicted, each sub-token may overlap in time with two sub-tokens from another token. This sub-token overlap may occur in parallel with the overlapping symbols within each sub-token depicted in FIG. 2.

In another example, increased bandwidth may be allocated for the IOS transmission. Increasing the available bandwidth may improve the inaudibility (by spreading the transmission power further and reducing amplitude) and detection (by allocating more frequency bandwidth for detection). Additionally, shorter symbols may be used to reduce latency, trading latency for inaudibility and detectability in this example. The symbol duration and bandwidth may be chosen to optimize audibility, detectability, and latency for each particular application of the IOS protocol.

In another example, available bandwidth may be subdivided into multiple frequency sub-bands. For example, within the 11-18 kHz frequency band, three frequency sub-bands, f₁, f₂, and f₃, may be created. In some examples, the frequency sub-bands may have some overlap. By dividing into sub-bands, the higher frequency sub-band may be more fully utilized, as greater power may be transmitted on the higher frequency sub-band. The increased power may be possible, for example, due to the non-linearity of human hearing, which may be less sensitive to higher frequency sub-band f₃ than to sub-band f₁, for example. Allocating more power to a higher-frequency sub-band may improve detectability overall. In some examples, frequency allocation may be performed dynamically, selecting frequency sub-bands based on detected conditions of device hardware, room conditions, and/or the like.

### Example Implementing Apparatus

FIG. 6 illustrates an example apparatus for IOS communication, used in accordance with various aspects of the present disclosure. For example, a television 102 or mobile device 110, described previously in connection with FIG. 1, may be embodied as an apparatus 600 or apparatus 650, respectively, as depicted in FIG. 6. Apparatus 600 includes processor 602, memory 604, and communication hardware 606, and may optionally include DAC 608 (digital-to-analog converter) and speaker 610. Apparatus 650 may include processor 652, memory 654, communication hardware 656, microphone 658, and ADC 660 (analog-to-digital converter). An apparatus 600 and/or apparatus 650 as depicted in FIG. 6 may include other circuitry and/or hardware not specifically described in connection with FIG. 6 (e.g., additional specialized circuitry, peripherals), and may be embodied by any computing device known in the art.

The processor 602 and processor 652 may be connected with the memory 604 communication hardware 606, (or memory 654 and/or communication hardware 656, respectively), and/or any other attached circuitry of the apparatus via a bus for passing information. In some examples processor 602 and processor 652 may include one or more hardware processors configured in tandem via a bus. The term “processor” as used herein may be understood to include a single core processor, a multi-core processor, multiple processors of the apparatus, remote or “cloud”processors, or any combination thereof.

Memory 604 and memory 654 are non-transitory and may include one or more volatile and/or non-volatile memories. For example, memory 604 and memory 654 may be random access memory, a hard disk, or any other electronic storage device (e.g., a computer readable storage medium). The memory 604 and memory 654 may be configured to store information, data, content, applications, software instructions, or the like, for enabling the apparatus to carry out various functions in accordance with various examples disclosed herein.

The communication hardware 606 and communication hardware 656 may be devices or circuitries embodied in either hardware or a combination of hardware, firmware, and software that are configured to receive and/or transmit data from or to a network and/or any other device wirelessly. Communication hardware 606 and communication hardware 656 may include a network interface and associated devices for communications with a wireless network, such as network interface cards, antennas, buses, switches, routers, modems, supporting hardware, and/or supporting software. The communication hardware 606 and communication hardware 656 may further include processing circuitry for causing transmission or handling receipt of signals to or from a network.

In addition to communication hardware 606 and communication hardware 656, an apparatus may further be configured to provide an input/output interface and receive an indication of user input. For example, an apparatus may comprise a display, keyboard, mouse, touch screen, microphone, speaker, and/or other input/output devices. The apparatus may further comprise software enabling a user to interact with the apparatus, including, for example, drivers, graphical user interfaces, web browsers, terminals, and/or the like.

The DAC 606 includes devices or circuitry embodied in either hardware or a combination of hardware, firmware, and software configured to produce analog audio signals from a digital input. The DAC 606 depicted in FIG. 6 may possess the capabilities of one or more of channel encoder 404, modulator 406, and/or spreading generator 408 depicted in FIG. 4. The DAC 606 may include input and output interfaces, power management components, and integrated circuits for processing of digital signals and preparation of analog signals with the desired properties. Likewise, the ADC 658 includes devices or circuitry embodied in either hardware or a combination of hardware, firmware, and software configured to produce digital audio signals from an analog input. The ADC 658 depicted in FIG. 6 may possess the capabilities of one or more of demodulator 410, spreading generator 412, and/or channel decoder 414 depicted in FIG. 4. The ADC 658 may include input and output interfaces, power management components, and integrated circuits for processing of analog signals and preparation of digital signals with the desired properties.

Speaker 610 and microphone 658 may be peripheral devices and associated hardware, software, and/or firmware components (e.g., amplifiers, drivers, and/or the like) for emitting and detecting sound waves. Speaker 610 and microphone 658 may have any range of response and sensitivity for various frequency spectra, and it will be understood that the IOS protocol may be configured with parameters chosen so that performance is maintained over a variety of models, qualities, and other properties of speaker 610 and/or microphone 658. For example, speaker 610 may have capabilities for emitting sounds in certain frequency ranges that may overlap with and/or go outside of human-detectable frequency ranges.

As noted above, apparatus 600 may optionally include DAC 608 and speaker 610. In examples in which apparatus 600 does not include a DAC 608 and/or a speaker 610, the apparatus 600 may be configured to transmit an encoded IOS token to a separate device, such as a television, that may perform digital to analog conversion and emit the sound corresponding to the IOS signal.

### Example Operations

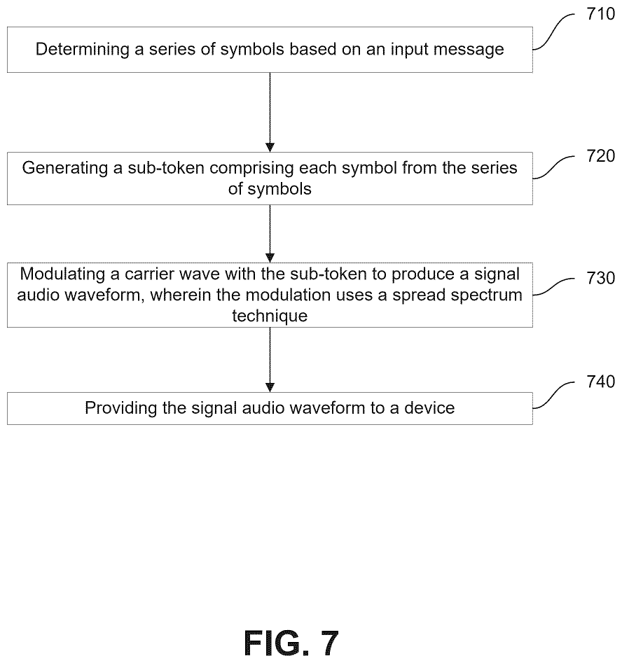

FIG. 7 is a block diagram illustrating an example process for IOS communication, in accordance with various aspects of the present disclosure. Example flowcharts are illustrated that contain operations implemented by various examples described herein. The operations illustrated in FIG. 7 may, for example, be performed by example system 100 depicted in FIG. 1, embodied by apparatus 600 and apparatus 650, which may be in communication with an external server or other devices. The operations described in connection with FIG. 7 may also be performed by other configurations or systems that differ from example system 100 described previously.

As shown by operation 710, an apparatus 600 includes means, such as processor 602, memory 604 and/or the like, for determining a series of symbols based on an input message. In some examples, each symbol from the series of symbols may represents a numerical (e.g., hexadecimal) value. In some examples, each symbol from the series of symbols may corresponds to a band-limited white noise tone, and each white noise tone may be orthogonal to each other band-limited white noise tone corresponding to each other symbol, as described previously in connection with FIG. 2. The tones may be orthogonal in the sense that, in an audio signal containing a mixture of two orthogonal tones, the orthogonal tones do not interact with each other. Practically speaking, this means that multiple symbols may be superimposed (e.g., emitted simultaneously) without negatively affecting the ability to detect both of the superimposed symbols.

In some examples, the known symbols may form an “alphabet” of symbols that may be constructed within the specifications of the IOS protocol for the given latency, inaudibility, and detectability requirements. Each symbol from the “alphabet” may correspond to a numerical value from a restricted range of values, allowing a system of tokens to be constructed from series of numerical values from the restricted range. A portion of the symbols from the “alphabet” may be reserved for control functions, such as a start symbol to indicate the beginning of a token, end symbol for the end of a token, error correction symbols, and/or the like. Other symbols may carry payload data that may be interpreted by the device receiving the message.

As shown by operation 720, an apparatus 600 includes means, such as processor 602, memory 604 and/or the like, for generating a sub-token comprising each symbol from the series of symbols. The processor 602 may look up the band-limited white noise representation of each symbol from the series of symbols and arrange the sequence of band-limited white noise tones into a sub-token. Within the structure of the sub-token, each symbol may overlap in time with at least one other symbol. For example, as shown in FIG. 2, a sub-token may include six overlapping symbols, the first symbol overlaps with the second symbol, the second symbol overlaps with the first and third symbols, and so on. The duration of the overlap may be decided by the duration of each symbol and the overlap delay, which may be configurable and selected to optimize latency, inaudibility, and detectability. For example, in the application of consumer home televisions emitting signals detectable by mobile phone devices in the same room, symbols of 0.25 s duration with an overlap delay of 0.125 s (for a sub-token of six symbols and tokens comprising three sub-tokens).

In some examples, the sub-token may be prepared together with one or more additional sub-tokens that make up a token. The sub-tokens may be independent, or overlapping as depicted in FIG. 5. In various examples, encoding tokens with overlapping sub-tokens, as shown in FIG. 5, may reduce latency.

As shown by operation 730, an apparatus 600 includes means, such as processor 602, memory 604 and/or the like, for modulating a carrier wave with the sub-token to produce a signal audio waveform, wherein the modulation uses a spread spectrum technique. As shown in FIG. 4, the modulation may use a spread spectrum technique from spread generator 408, and the digital signal may be previously encoded using a channel encoder 404. The spread spectrum technique may be any spread spectrum technique known in the art. For example, in an application of consumer home televisions emitting signals detectable by mobile phone devices in the same room, direct sequence spread spectrum was used. The spread spectrum technique, as discussed previously in connection with FIG. 3, offers the advantage of reduced audibility by lowering the maximum amplitude reached at each signal frequency. The modulated signal audio waveform may be stored as a digital signal to be send to a DAC 608 for later conversion to analog signal and transmission.

As shown by operation 740, an apparatus 600 may include means, such as communication hardware 606 and/or the like, for providing the signal audio waveform for transmission. For example, the communication hardware 608 may provide the signal audio waveform to a television device to be transmitted. In some examples, an on-board DAC 608 and speaker 610 may directly transmit the audio signal.

In some examples, the signal audio waveform may be embedded or otherwise added to an existing audio signal. For example, an audio signal may be played from a television program, either from local storage or streamed from a network, and the signal audio waveform may be embedded in the audio stream of the television program to create a combined audio stream. In some examples, the signal audio waveform may be embedded at a previous time, for example, so that the combined audio stream may be stored locally or on a server for streaming the combined audio stream. In some examples, the combined audio stream may be formed in real time, so that the audio signal from the media may be retrieved or streamed, combined with the IOS signal audio waveform, and formed into a combined audio stream without committing the combined audio stream to long-term storage. In this way, the IOS system may be configured to transmit different signals depending on instructions received from an application, which may be determined based on various conditions detected in the audio stream. For example, an audio stream for a classic film may be embedded with advertisements for new products that are relevant to the classic film at a particular timestamp.

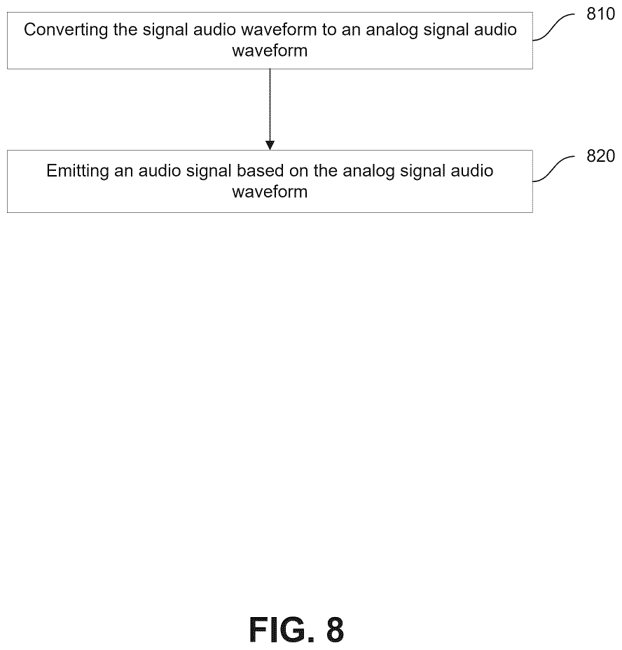

Turning now to FIG. 8, example operations are shown for emitting a signal via inaudible orthogonal signal communication. As shown by operation 810, an apparatus 600 may include means, such as DAC 608 and/or the like, for converting the signal audio waveform to an analog signal audio waveform. The DAC 608 may perform the various operations described in connection with FIG. 6 to produce an analog audio waveform to be emitted by the speaker 610. As noted above, the analog signal audio waveform may include both the IOS output and any base audio data into which the IOS information may be embedded.

As shown by operation 820, an apparatus 600 may include means, such as speaker 610 and/or the like, for emitting an audio signal based on the analog signal audio waveform. The audio signal may be inaudible for the conditions under which the IOS transmission is expected to be performed. For example, the audio signal may include a signal component with a component frequency in the human-detectable frequency auditory range and/or a component outside the human-detectable frequency auditory range (e.g., a hardware capability range of the speaker 610). As shown in FIG. 3, the audio signal may be spread over a wide range of frequency bands. Since human hearing has different sensitivities in each frequency band, the concept of inaudibility may include varying the amplitude of the signal based on the frequency band. Accordingly, the signal component (which may be within the hardware capability range of speaker 610) may have a component amplitude below the human-detectable auditory amplitude range for the component frequency range. The signal component's component amplitude may be below the human-detectable auditory amplitude range under the assumption of a volume setting on the transmitting device (e.g., the volume on a television) within a standard assumed operating range. For example, the amplitude may be chosen to achieve 100% inaudibility for a television volume set to below 75 dBSPL.

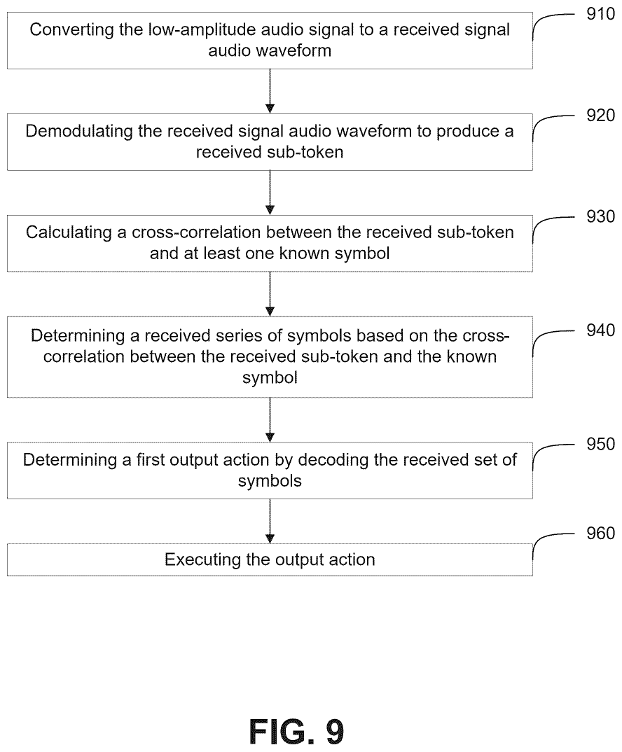

Turning now to FIG. 9, example operations are shown for receiving a signal via inaudible orthogonal signal communication. As shown by operation 910, an apparatus 650 includes means, such as microphone 658, ADC 660, and/or the like, for converting the low-amplitude audio signal to a received signal audio waveform. The microphone 658 may produce an analog signal which may be converted to a digital signal by ADC 660 for further processing.

As shown by operation 920, an apparatus 650 includes means, such as processor 652, memory 654, and/or the like, for demodulating the received signal audio waveform to produce a received sub-token. Demodulating the received signal audio waveform may include de-spreading, as depicted in FIG. 4, by the combination of spreading generator 412 and demodulator 410. The processor 652 may perform demodulation and de-spreading to convert the modulated received signal audio waveform to a received sub-token.

In some examples, the sub-token may be received together with one or more additional sub-tokens that make up a token. The sub-tokens may be independent and separated in time, or may be overlapping as depicted in FIG. 5.

As shown by operation 930, an apparatus 650 includes means, such as processor 652, memory 654, and/or the like, for calculating a cross-correlation between the received sub-token and at least one known symbol. The cross-correlation may be determined by comparing the received sub-token to each known symbol from the full set of known symbols of an “alphabet” of symbols. Since each symbol is orthogonal to each other symbol, the cross-correlation for each symbol may be tested independently to determine the presence or absence of the tested symbol.

As shown by operation 940, an apparatus 650 includes means, such as processor 652, memory 654, and/or the like, for determining a received series of symbols based on the cross-correlation between the received sub-token and the known symbol, wherein the received series of symbols is identical to the series of symbols. A peak detected in the cross-correlation for a given symbol indicates a positive identification of the tested symbol. The process may be repeated for each known symbol to establish each symbol in the received series of symbols. The timing of the tested symbol may be determined by isolating the tested cross-correlation to a time period (for example, 0.25 second intervals for 0.25 s length symbols) and the ordering of received symbols may be determined thusly.

As shown by operation 950, an apparatus 650 includes means, such as processor 652, memory 654, and/or the like, for determining a first output action by decoding the received set of symbols. For example, the output action may include displaying an advertisement as a push notification on the user device. The processor 652 may decode the first set of symbols to determine one or more control signals that indicate that an advertisement should be displayed to the user. The symbols may indicate the timing, the mode of display, how to determine the contents of the display, and/or the like.

As shown by operation 960, an apparatus 660 includes means, such as processor 652, memory 654, communication hardware 656, and/or the like, for executing the output action. For example, the output action may include displaying an advertisement as a push notification on the user device. The processor 652 may look up data to retrieve the advertisement information based on the series of symbols, retrieve the advertisement display information, and display it using communication hardware 656.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A system comprising:
a first electronic device comprising one or more first processors and one or more first computer readable media storing first processor executable instructions which, when executed using the one or more first processors, cause the first electronic device to perform operations comprising:
determining, based on an input message, a series of symbols, wherein each symbol from the series of symbols represents a numerical value, wherein each symbol from the series of symbols corresponds to a band-limited white noise tone orthogonal to each other band-limited white noise tone corresponding to each other symbol,
generating a sub-token comprising each symbol from the series of symbols, wherein each symbol overlaps in time with at least one other symbol,
modulating a carrier wave with the sub-token to produce a signal audio waveform, wherein the modulation uses a spread spectrum technique, and
providing the signal audio waveform to a television device;
the television device comprising:
a digital to analog converter configured to convert the signal audio waveform to an analog signal audio waveform, and
a speaker configured to emit an audio signal based on the analog signal audio waveform, wherein the audio signal comprises a signal component with a component frequency in a hardware capability range of the speaker, wherein the signal component has a component amplitude below a human-detectable auditory amplitude range for the component frequency range; and
a mobile electronic device comprising one or more second processors, a microphone, one or more second computer readable media storing second processor executable instructions which, when executed using the one or more second processors, cause the mobile electronic device to perform operations comprising:
converting, by the microphone, the low-amplitude audio signal to a received signal audio waveform,
demodulating the received signal audio waveform to produce a received sub-token;
calculating a cross-correlation between the received sub-token and at least one known symbol,
determining a received series of symbols based on the cross-correlation between the received sub-token and the known symbol, wherein the received series of symbols is identical to the series of symbols;
determining a first output action by decoding the received set of symbols; and
executing the output action.

2. The system of claim 1, wherein the one or more first computer readable media store additional processor executable instructions which, when executed using the one or more first processors, cause the first electronic device to perform further operations comprising:
embedding the signal audio waveform in a media waveform to produce a signal embedded media waveform; and
providing the signal embedded media waveform to the television device, wherein the signal embedded media waveform comprises the signal audio waveform.

3. The system of claim 1, wherein the output action comprises displaying an advertisement related to first content, wherein the low-amplitude signal is transmitted at or before a timestamp of a media file currently in playback on the television, wherein an instance of the first content is associated with the timestamp of the media file.

4. A method comprising:
storing first data indicating a first set of band-limited, fixed-length white noise symbols,
determining, at an electronic device based on a first signal generated using one or more microphones of the electronic device based on first sound, first signal data,
determining a first correlation value indicating a correlation between a first portion of the first signal data and a predefined symbol,
based on the determining of the first correlation value, determining a first time associated with a start of a first token,
based on the determining of the first time, determining a first plurality of correlation values for a second portion of the first signal data that begins at the first time and ends at a second time associated with an end of the first token, each respective correlation value of the first plurality of correlation values indicating a correlation between the second portion of the first signal data and a respective symbol of the first set,
determining, based on the first plurality of correlation values, a first symbol of the first set that corresponds to the second portion of the first signal data,
based on the determining of the first correlation value, determining a third time associated with a start of a second token,
based on the determining of the third time, determining a second plurality of correlation values for a third portion of the first signal data that begins at the third time and ends at a fourth time associated with an end of the second token, each respective correlation value of the second plurality of correlation values indicating a correlation between the third portion of the first signal data and a respective symbol of the first set,
determining, based on the second plurality of correlation values, a second symbol of the first set that corresponds to the third portion of the first signal data, and
determining, based on the determining of the first symbol and the determining of the second symbol, first message data,
wherein the third time associated with the start of the second token is before the second time associated with the end of the first token, and
wherein the first sound has a frequency between 13 kHz and 16 kHz.

5. The method of claim 4, wherein the method further comprises
based on the determining of the first correlation value, determining a fifth time associated with a start of a third token,
based on the determining of the fifth time, determining a third plurality of correlation values for a fourth portion of the first signal data that begins at the fifth time and ends at a sixth time associated with an end of the third token, each respective correlation value of the third plurality of correlation values indicating a correlation between the fourth portion of the first signal data and a respective symbol of the first set,
determining, based on the third plurality of correlation values, a third symbol of the first set that corresponds to the fourth portion of the first signal data, and
wherein the first message data is determined based on the determining of the third symbol,
wherein the fifth time associated with the start of the third token is before the fourth time associated with the end of the second token.

6. The method of claim 4, wherein the first signal data is a digital representation of the first signal.

7. The method of claim 4, wherein the method comprises
determining, based on the first signal and using an analog to digital converter, digital data, and
determining, based on the digital data, the first signal data.

8. The method of claim 4, wherein the method comprises
determining, based on the first signal and using an analog to digital converter, digital data, and
determining, using the digital data and despreading data, the first signal data.

9. The method of claim 4, wherein the method comprises
determining, based on the first signal and using an analog to digital converter, digital data, and
determining, using the digital data and a spreading generator, the first signal data.

10. The method of claim 4, wherein the determining of the first correlation value involves convolution of the first portion of the first signal data with data representing a functional inverse of the predefined symbol.

11. The method of claim 4, wherein the electronic device comprises a television.

12. The method of claim 4, wherein the first message data comprises authentication data.

13. The method of claim 4, wherein the method comprises determining, based on the first message data, authentication data, and sending, to a remote system, authentication to effect sign on to a service.

14. The method of claim 4, wherein the first message data comprises authentication data.

15. An electronic device comprising:
one or more microphones;
one or more processors; and
one or more computer readable media storing processor executable instructions which, when executed using the one or more processors, cause the electronic device to perform operations comprising
storing first data indicating a first set of band-limited, fixed-length white noise symbols,
determining, based on a first signal generated using the one or more microphones of the electronic device based on first sound, first signal data,
determining a first correlation value indicating a correlation between a first portion of the first signal data and a predefined symbol,
based on the determining of the first correlation value, determining a first time associated with a start of a first token,
based on the determining of the first time, determining a first plurality of correlation values for a second portion of the first signal data that begins at the first time and ends at a second time associated with an end of the first token, each respective correlation value of the first plurality of correlation values indicating a correlation between the second portion of the first signal data and a respective symbol of the first set,
determining, based on the first plurality of correlation values, a first symbol of the first set that corresponds to the second portion of the first signal data,
based on the determining of the first correlation value, determining a third time associated with a start of a second token,
based on the determining of the third time, determining a second plurality of correlation values for a third portion of the first signal data that begins at the third time and ends at a fourth time associated with an end of the second token, each respective correlation value of the second plurality of correlation values indicating a correlation between the third portion of the first signal data and a respective symbol of the first set,
determining, based on the second plurality of correlation values, a second symbol of the first set that corresponds to the third portion of the first signal data, and
determining, based on the determining of the first symbol and the determining of the second symbol, first message data,
wherein the third time associated with the start of the second token is before the second time associated with the end of the first token, and
wherein the first sound has a frequency between 13 kHz and 16 kHz.

16. The electronic device of claim 15, wherein the electronic device is a television.

17. The electronic device of claim 15, wherein the electronic device is a smart assistant device.

18. The electronic device of claim 15, wherein the electronic device is a security camera or video doorbell device.

19. The electronic device of claim 15, wherein the electronic device is a tablet or e-reader device.

20. The electronic device of claim 15, wherein the electronic device is a wireless router or access point device, or a smart home hub device, or a security system hub device.
